(19) United States
(12) Patent Application Publication
(10) Pub. No.: US 2026/0064695 A1
(43) Pub. Date: Mar. 5, 2026

(54) SIMILAR DATA SEARCH SYSTEM, TRAINING SYSTEM, AND SIMILAR DATA SEARCH METHOD

(71) Applicant: KABUSHIKI KAISHA TOSHIBA, Kawasaki-shi Kanagawa (JP)

(72) Inventors: Susumu NAITO, Yokohama Kanagawa (JP); Kouta NAKATA, Chigasaki Kanagawa (JP); Yasunori TAGUCHI, Kawasaki Kanagawa (JP)

(73) Assignee: KABUSHIKI KAISHA TOSHIBA, Kawasaki-shi Kanagawa (JP)

(21) Appl. No.: 19/312,676

(22) Filed: Aug. 28, 2025

(30) Foreign Application Priority Data
Sep. 5, 2024 (JP) 2024-153179

(51) Int. Cl. G06F 16/2457; G06N 3/0455; G06N 3/08

(52) U.S. Cl. CPC G06F 16/2457; G06N 3/0455; G06N 3/08

(57) ABSTRACT

According to one embodiment, similar data search system includes a processor. The processor acquires a query data set including measurement values. The processor generates, based on the query data set and a registration data set, an input data set representing a difference between the query data set and the registration data set. The processor inputs the input data set to a trained model. The processor acquires an output data set output by the trained model or an intermediate output data set that is an intermediate output of the trained model. The processor calculates similarity between the query data set and the registration data set based on the output data set or the intermediate output data set. The processor searches a database based on the similarity.

### CROSS-REFERENCE TO RELATED APPLICATIONS

This application is based upon and claims the benefit of priority from Japanese Patent Application No. 2024-153179, filed Sep. 5, 2024, the entire contents of which are incorporated herein by reference.

### FIELD

Embodiments described herein relate generally to a similar data search system, a training system, and a similar data search method

### BACKGROUND

In a large-scale plant such as a power plant, a large number of pieces of process data are acquired for the purpose of monitoring the performance of the plant and the soundness of various systems and devices constituting the plant. It is difficult for plant operators to constantly monitor all of a large number of pieces of process data. For this reason, many plants are provided with a monitoring system that detects an anomaly change in the plant using process data.

There is a method of performing a cause analysis of an anomaly change from the past process data by searching the past process data similar to an anomaly change of current process data from a database or the like. However, since the fluctuations of the process data of the plant are complicated, in a case where the past process data similar to the minute fluctuation of the current process data is searched, the past process data similar to the large fluctuation of the current process data but not similar to the minute fluctuation is searched.

### BRIEF DESCRIPTION OF DRAWINGS

FIG. 1 is a diagram illustrating a configuration example of a similar data search system according to the first embodiment.

FIG. 2 is a diagram schematically illustrating processing of collecting a registration data set according to the first embodiment.

FIG. 3 is a diagram illustrating a processing procedure of similar data search processing according to the first embodiment.

FIG. 4 is a diagram schematically illustrating a processing procedure of similarity calculation processing according to the first embodiment.

FIG. 5 is a diagram schematically illustrating a processing procedure of input data set generation processing according to the first embodiment.

FIG. 6 is a diagram illustrating data stored in the database according to the first embodiment.

FIG. 7 is a diagram illustrating a display screen according to the first embodiment.

FIG. 8 is another diagram illustrating a display screen according to the first embodiment.

FIG. 9 is a diagram illustrating a configuration example of a similar data search system according to the first modification.

FIG. 10 is a diagram illustrating a processing procedure of training processing of a machine learning model according to the first modification.

FIG. 11 is a diagram schematically illustrating a processing procedure of training processing of a machine learning model according to the first modification.

FIG. 12 is a diagram illustrating a configuration example of a similar data search system according to the second modification.

FIG. 13 is a diagram schematically illustrating a processing procedure of generation processing of a first composite data set according to the second modification.

FIG. 14 is a diagram illustrating a verification result of a similar data search system according to the second modification.

FIG. 15 is a diagram illustrating a configuration example of a training system according to the second embodiment.

### DETAILED DESCRIPTION

The similar data search system according to the embodiment includes an acquisition unit, a database, a generation unit, an inference unit, a calculation unit, and a search unit. The acquisition unit acquires a query data set including measurement values of a plurality of sensors. The database stores a registration data set including measurement values of the plurality of sensors. The generation unit generates an input data set representing a difference between the query data set and the registration data set based on the query data set and the registration data set. The inference unit inputs the input data set to a trained model, and acquires an output data set output by the trained model or an intermediate output data set that is an intermediate output of the trained model. The calculation unit calculates similarity between the query data set and the registration data set based on the output data set or the intermediate output data set. The search unit searches the database based on the similarity.

### First Embodiment

Hereinafter, a similar data search system, a training system, and a similar data search method according to the present embodiment will be described with reference to the drawings. Hereinafter, the term “distance” is treated as a term indicating a Euclidean distance between two pieces of data. However, the distance is not limited to the Euclidean distance. The distance according to the present embodiment can be applied to, for example, a Manhattan distance, a Chebyshev distance, a Hamming distance, a Mahalanobis distance, or the like.

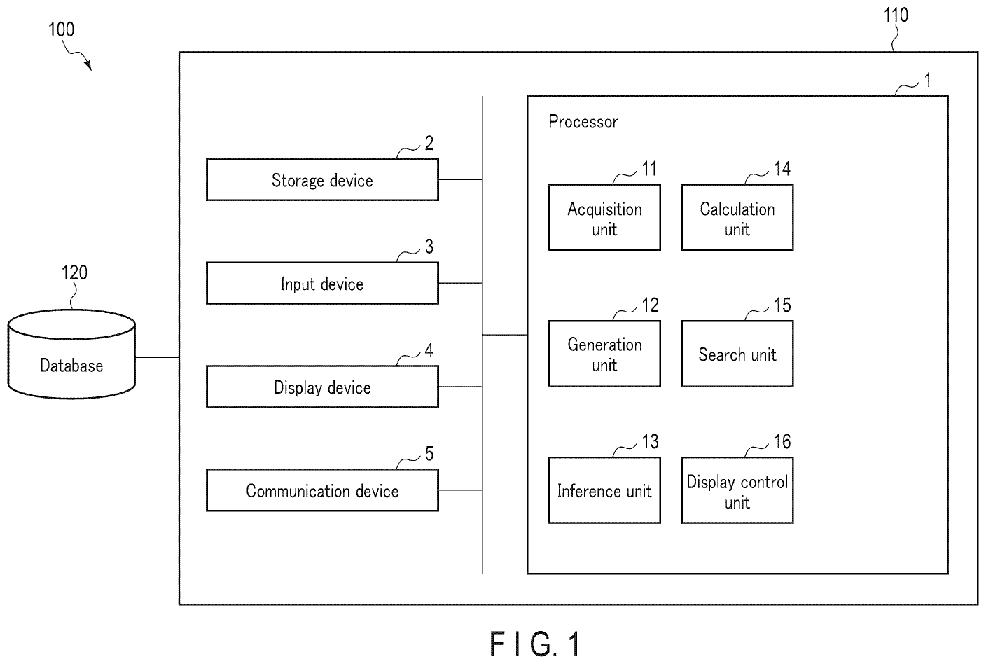

FIG. 1 is a diagram illustrating a hardware configuration example of a similar data search system 100 according to the first embodiment. As illustrated in FIG. 1, the similar data search system 100 includes an information processing apparatus 110 and a database 120. The information processing apparatus 110 is a computer including a processor 1, a storage device 2, an input device 3, a display device 4, and a communication device 5. Transmission and reception of data and various signals of the processor 1, the storage device 2, the input device 3, the display device 4, and the communication device 5 are performed via a bus (Bus). As an example, the similar data search system 100 is a system in which the information processing apparatus 110 is an edge device such as a personal computer and the database 120 is a server computer.

The processor 1 is an integrated circuit that controls the entire operation of the information processing apparatus 110. For example, the processor 1 includes a central processing unit (CPU), a graphics processing unit (GPU), a digital signal processor (DSP), and/or a floating-point unit (FPU).

The processor 1 may include an internal memory or an I/O interface. The processor 1 executes various processes by interpreting and calculating a program stored in advance by the storage device 2 or the like. A part or the whole of the processor 1 may be realized by hardware such as an application specific integrated circuit (ASIC) or a field programmable gate array (FPGA).

The storage device 2 is a volatile memory and/or a nonvolatile memory that stores various pieces of data. For example, the storage device 2 stores data and setting values used in a case where the processor 1 executes various processes, data generated by various processes in the processor 1, and the like. The storage device 2 includes a read only memory (ROM) and a random access memory (RAM), a hard disk drive (HDD), a solid state drive (SSD), an integrated circuit storage device, and the like. Note that the storage device 2 may include a non-transitory computer-readable storage medium that stores a program executed by the processor 1.

The input device 3 receives inputs of various operations from an operator. As the input device 3, a keyboard, a mouse, various switches, a touch pad, a touch panel display, and the like can be used. An electric signal (hereinafter, the operation signal) corresponding to the input of the received operation is supplied to the processor 1.

The display device 4 displays various pieces of data under the control of the processor 1. As the display device 4, a cathode-ray tube (CRT) display, a liquid crystal display, an organic electro luminescence (EL) display, a light-emitting diode (LED) display, a plasma display, or any other display can be appropriately used. The display device 4 may be a projector.

The communication device 5 includes a communication interface including a network interface card (NIC) for performing data communication with various devices connected to the information processing apparatus 110 via a network. Note that an operation signal may be supplied from a computer connected via the communication device 5 or an input device included in the computer, or various pieces of data may be displayed on a display device or the like included in the computer connected via the communication device 5. However, in order to simplify the following description, unless otherwise specified, it is assumed that the supply source of the operation signal is the input device 3 and the display destination of various pieces of data is the display device 4. The input device 3 can be replaced with a computer connected via the communication device 5 or an input device included in the computer, and the display device 4 can be replaced with a display device or the like included in the computer connected via the communication device 5.

The information processing apparatus 110 does not need to include all of the processor 1, the storage device 2, the input device 3, the display device 4, and the communication device 5. When necessary, some of the storage device 2, the input device 3, the display device 4, and the communication device 5 may not be provided. The information processing apparatus 110 may be provided with any additional hardware device useful for executing the processing according to the present embodiment. The information processing apparatus 110 does not need to be physically configured by one computer, and may be configured by a computer system including a plurality of computers communicably connected via a wired or network line or the like. The allocation of the series of processes according to the present embodiment to the plurality of processors 1 mounted on the plurality of computers can be set in any manner. All the processors 1 may execute all the processes in parallel, or a specific process may be assigned to one or some of the processors 1, and a series of processes according to the present embodiment may be executed as the entire computer system.

As illustrated in FIG. 1, the processor 1 includes functional configurations such as an acquisition unit 11, a generation unit 12, an inference unit 13, a calculation unit 14, a search unit 15, and a display control unit 16.

The acquisition unit 11 acquires various pieces of data related to similar data search. For example, the acquisition unit 11 acquires a query data set including measurement values of a plurality of sensors.

The generation unit 12 generates an input data set representing a difference between the query data set and the registration data set based on the query data set and the registration data set. The registration data set is a data set stored in the database 120.

The inference unit 13 inputs an input data set to the trained model and acquires an output data set output by the trained model or an intermediate output data set that is an intermediate output of the trained model.

The calculation unit 14 calculates the similarity between the query data set and the registration data set based on the output data set or the intermediate output data set.

The search unit 15 searches the database 120 based on the similarity.

The display control unit 16 displays various types of information related to the similar data search on the display device 4. The display control unit 16 displays the search result of the search unit 15 on the display device 4, for example.

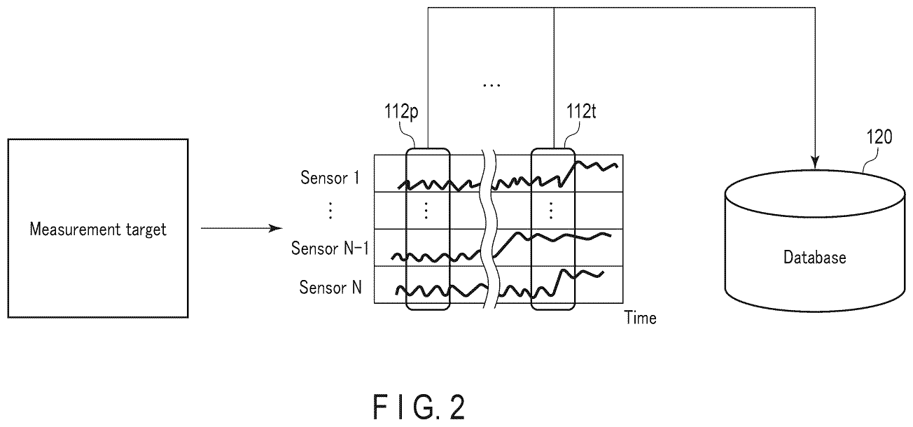

The database 120 stores a registration data set including measurement values of a plurality of sensors. FIG. 2 is a diagram illustrating collection of a registration data set. As illustrated in FIG. 2, multivariate time-series data is collected from a measurement target via a plurality of sensors. The multivariate time-series data is time-series data in which each piece of sensor data output by a plurality of sensors is set as one variable. The multivariate time-series data has, for example, sensor data collected via N sensors from a sensor 1 to a sensor N. However, the multivariate time-series data may be data obtained by performing data processing such as a noise reduction process on the sensor data. As an example, the multivariate time-series data is a plurality of pieces of input time-series data respectively corresponding to a plurality of process quantities generated in the target facility. The target facility is, for example, a plant including a power plant, an industrial plant, and the like. The input time-series data is, for example, time-series data of a process quantity of the plant.

Hereinafter, the time-series data of the process quantity is referred to as process quantity data. The collected multivariate time-series data is divided into a plurality of segments divided at predetermined time intervals. More specifically, the multivariate time-series data is divided along a time-series. The database 120 stores one divided segment as one registration data set.

Specifically, each of the plurality of segments including a first segment 112p and a second segment 112t that are obtained by dividing the data is stored in the database 120 as the registration data set.

In addition, supplementary information may be stored in association with the registration data set. The supplementary information includes, for example, a measurement date and time and/or a name of a sensor. Note that the supplementary information is not limited to the above content. For example, the supplementary condition associated with the plant amount data may further include an operation condition of the plant and the like.

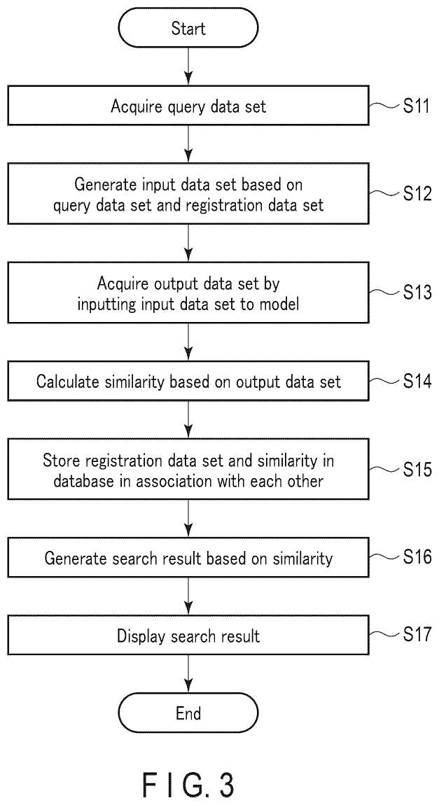

Hereinafter, a description will be given on the assumption that each of a plurality of segments obtained by dividing, for each predetermined time, multivariate time-series data corresponding to a plurality of process quantities generated in a plant is stored in the database 120 as a registration data set. However, the database 120 is not limited to storing a plurality of registration data sets. The measurement target is not limited to the plant. The measurement target may be, for example, a weather phenomenon, a human, a car, or the like. In addition, the type of data of the registration data set is not limited to the process quantity data. The data type of the registration data set may be, for example, multivariate time-series data including weather data, brain wave data, physical activity data, and the like, and image data or video data including facial photograph data, fingerprint data, a drive recorder, and the like. FIG. 3 is a diagram illustrating a processing procedure of searching for a registration data set similar to the query data set according to the first embodiment.

As illustrated in FIG. 3, the acquisition unit 11 acquires a query data set (step S11). The query data set is used as a search query in a case where a registration data set satisfying a specific condition is searched from a plurality of registration data sets stored in the database 120. The specific condition is, for example, that the similarity between the query data set and the registration data set is equal to or greater than a threshold value. The query data set may be of the similar data type as the registration data set stored in the database 120. The similar data type indicates, for example, that a variable corresponding to each of a plurality of variables included in the registration data set is included. However, the query data set is not limited to the same measurement target as the registration data set. The measurement target of the query data set may be a type of the measurement target related to the registration data set. The predetermined time is preferably defined to be substantially the same as the time when the registration data set stored in the database 120 is divided. Specifically, the acquisition unit 11 acquires, as a query data set, process quantity data in which part, of the process quantity data of the plant, in which the anomaly is detected is cut out in a predetermined time.

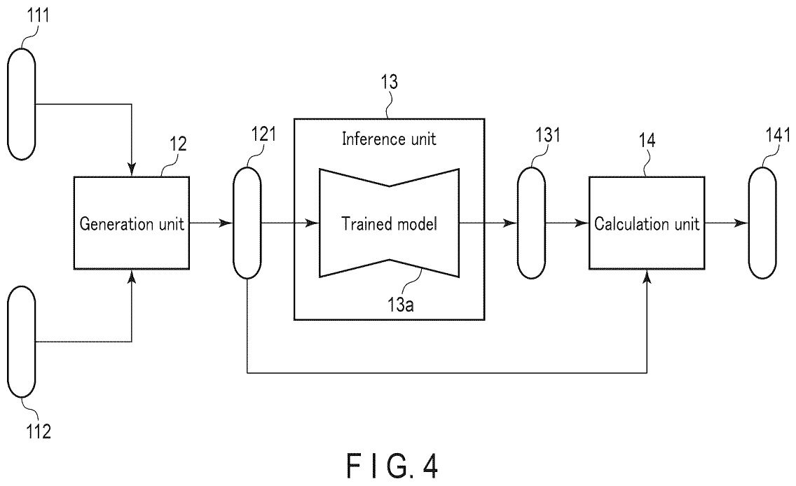

FIG. 4 is a block diagram illustrating a flow of processing from step S12 to step S14. Hereinafter, the flow of processing from step S12 to step S14 will be described with reference to FIG. 4.

In a case where step S11 is performed, the generation unit 12 generates an input data set 121 based on a query data set 111 acquired in step S11 and a registration data set 112 stored in the database 120 (step S12). As an example, the input data set 121 is a difference between the query data set 111 and the registration data set 112. More specifically, the generation unit 12 takes a difference for each corresponding process quantity data between the query data set 111 and the registration data set 112.

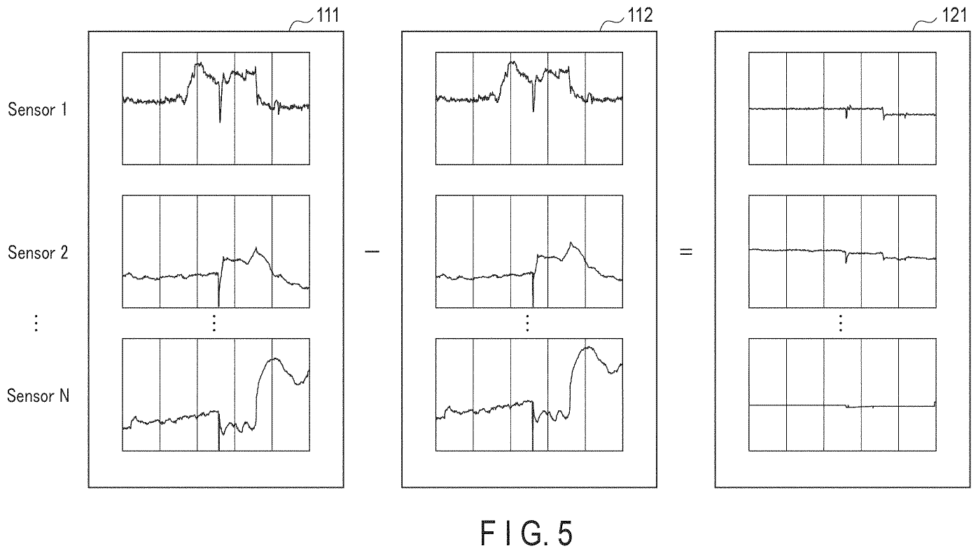

FIG. 5 is a diagram illustrating generation processing of the input data set 121. As illustrated in FIG. 5, each of the query data set 111 and the registration data set 112 is one segment among a plurality of segments obtained by dividing multivariate time-series data having N pieces of time-series data every predetermined time. The time-series data from 1 to N are different data measured by different sensors on the same time axis. Therefore, the horizontal axis of each of the N graphs included in the query data set 111 or the registration data set 112 is the same time axis, and the vertical axis represents signal intensity of different process quantities. The process quantity data of the query data set 111 and the process quantity data included in the registration data set 112 related to the sensor of the same number are process quantity data collected by the same sensor. The input data set 121 is generated by taking a difference for each of N pieces of process quantity data between the query data set 111 and the registration data set 112. As a result, in a case where the distance between the data sets is long, fluctuations between the data sets overlap each other, and an input data set having a large size is generated. On the other hand, in a case where the distance between the data sets is short, fluctuations common between the data sets cancel each other, and an input data set having a small size is generated. The size is, for example, an L2 norm. Note that, although it is described that the input data set 121 is generated by subtracting the registration data set 112 from the query data set 111, the present invention is not limited thereto. For example, the input data set 121 may be generated by subtracting the query data set 111 from the registration data set 112.

In a case where step S12 is performed, the inference unit 13 inputs the input data set 121 calculated in step S12 to a trained model 13a, and acquires an output data set 131 output by the trained model 13a (step S13). As an example, as illustrated in FIG. 4, the trained model 13a is an autoencoder that receives the input data set 121, reduces the dimension of the input data set 121, and outputs the output data set 131 restored to the dimension of the input data set 121. The output data set 131 is, for example, a data set obtained by reconstructing the input data set 121. Specifically, the trained model 13a is, for example, an autoencoder trained to receive a training data set that is a difference between two different registration data sets 112 of the plurality of registration data sets 112 stored in the database 120 to output an output data set 13a that restores the input training data set.

In more detail, the training apparatus inputs the training data set to an untrained autoencoder to calculate an output data set, and updates parameters such as a weight parameter and a bias of the untrained autoencoder so as to minimize an error between the training data set and the output data set in a case where the size of the training data set is small, in other words, in a case where the distance between the two registration data sets is short. The parameter update is repeated until a predetermined stop condition is satisfied. A set of parameters in a case where a predetermined stop condition is satisfied is assigned to an untrained autoencoder, whereby the trained autoencoder is completed. The trained model 13a is stored in the storage device 2, for example, and processing is executed by the information processing apparatus 110.

By inputting the difference between the query data set 111 and the registration data set 112 to the trained model 13a, it is possible to acquire the output data set 131 in consideration of the minute fluctuation between data.

Note that the trained model 13a is not limited to being stored in the storage device 2. For example, the inference unit 13 may cause an external processor to process a trained model stored in the database 120 or an external storage device by cloud computing or the like, and acquire an output data set from the outside.

In a case where step S13 is performed, the calculation unit 14 calculates similarity 141 between the query data set 111 acquired in step S11 and the registration data set 112 used to generate the input data set in step S12 based on the output data set 131 acquired in step S13 (step S14). For example, the calculation unit 14 calculates the similarity 141 based on a reconstruction error between the input data set generated in step S12 and the output data set acquired in step S13. As a specific example, the similarity 141 is a reciprocal of the magnitude of the reconstruction error or the like. The reconstruction error is a difference between data input to the autoencoder and data output by the autoencoder with respect to the input data. The smaller the reconstruction error, the higher the similarity 141 may be treated. Since the calculation unit 14 calculates one similarity 141 for one input data set 121, one similarity 141 is calculated for one registration data set 112.

Before executing step S15, the processing from step S12 to step S14 is executed for all the plurality of registration data sets 112 stored in the database 120. Specifically, the generation unit 12 generates a plurality of input data sets 121 based on all the plurality of registration data sets 112 stored in the database 120 and the query data set 111. Steps S13 and S14 are executed for each of the plurality of pieces of generated input data sets 121.

Note that the processing from step S12 to step S14 may be repeated until all the registration data sets 112 among the plurality of registration data sets 112 are executed.

In a case where step S14 is performed, the database 120 stores the similarity calculated in step S14 in association with the corresponding registration data set (step S15).

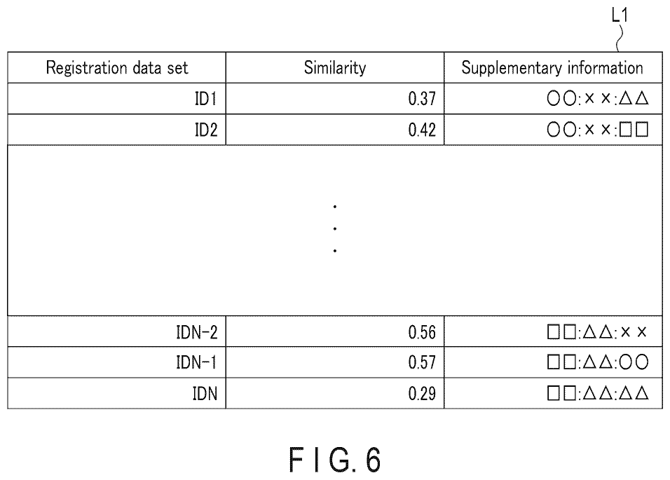

FIG. 6 is a diagram illustrating the registration data set and the similarity stored in the database 120. As illustrated in FIG. 6, the database 120 stores a list L1 in which the similarity calculated based on the registration data set and supplementary information about the registration data set is associated with the registration data set. N registration data sets from 1 to N are stored in the database 120. The registration data sets are stored, for example, in chronological order in the multivariate time-series data before being divided. The supplementary information is information such as a measurement date and time and/or a name of a sensor of the registration data set stored in advance in association with the registration data set. The similarity is an index indicating the degree of similarity of the registration data set to the query data set. For example, in a case of calculated in step S14, the similarity is sequentially stored in the database 120 in association with the corresponding registration data set.

Note that the correspondence relationship between the registration data set and the similarity is not limited to being stored in a list format, and may be stored in any format as long as the registration data set and the similarity are associated with each other. In addition, the similarity and the correspondence relationship between the registration data set and the similarity are not limited to being stored in the database 120. For example, the similarity and the correspondence relationship between the registration data set and the similarity may be stored in the storage device 2 or may be stored in an external storage device as long as the processor 1 can read the similarity and the correspondence relationship.

In a case where step S15 is performed, the search unit 15 generates a search result based on the similarity calculated in step S14 (step S16). As an example, the search unit 15 generates a search result as a list in which some or all of the plurality of registration data sets stored in the database 120 are disposed in order of magnitude relationship between the similarities.

Specifically, the search result is in the form of a list in which similarity exceeding a predetermined threshold value among the plurality of registration data sets is disposed in descending order. The predetermined threshold value may be a statistical value such as a median or an average based on all the similarities calculated in step S14, or may be a value determined by the user in any manner. Note that the search result is not limited to the above format. For example, the search unit 15 may generate a search result including only the registration data set having the highest similarity.

In a case where step S16 is performed, the display control unit 16 displays the search result generated in step S16 (step S17).

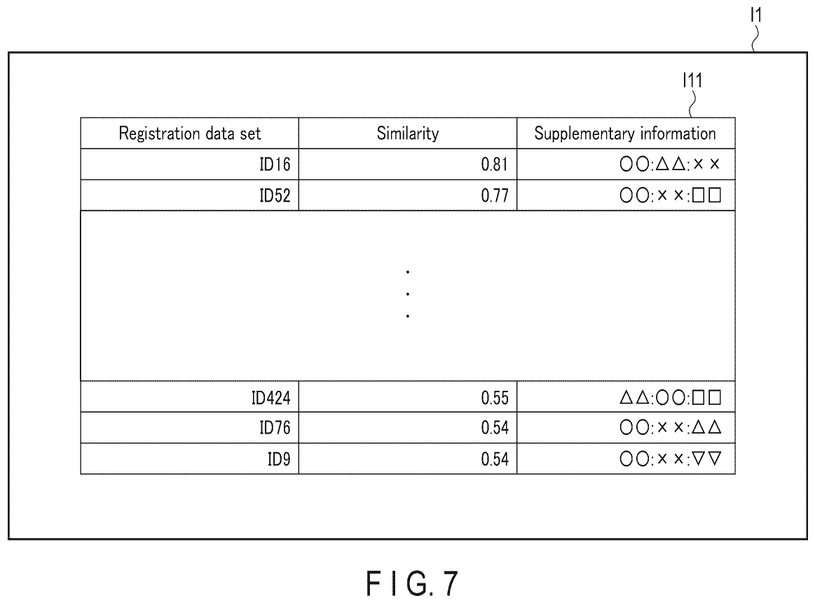

FIG. 7 is a diagram illustrating a display screen I1 for displaying a search result. The display screen I1 of FIG. 7 includes a display field 111. In the display field I11, a list of identification information of the registration data set, similarity, and supplementary information is displayed. The list is disposed in descending order of similarity. The identification information is information for identifying each of the plurality of registration data sets stored in the database 120. The supplementary information is information such as a measurement date and time and/or a name of a sensor stored in association with the registration data set stored in the database 120. The similarity is an index indicating that the registration data set and the query data set are similar the data sets as the similarity increases. A higher position in the list indicates that the registration data set is similar to the query data set. For example, the list row may be selectively displayed. By displaying the search results based on the similarity, it is possible to easily identify a registration data set similar to the query data set from a plurality of registration data sets.

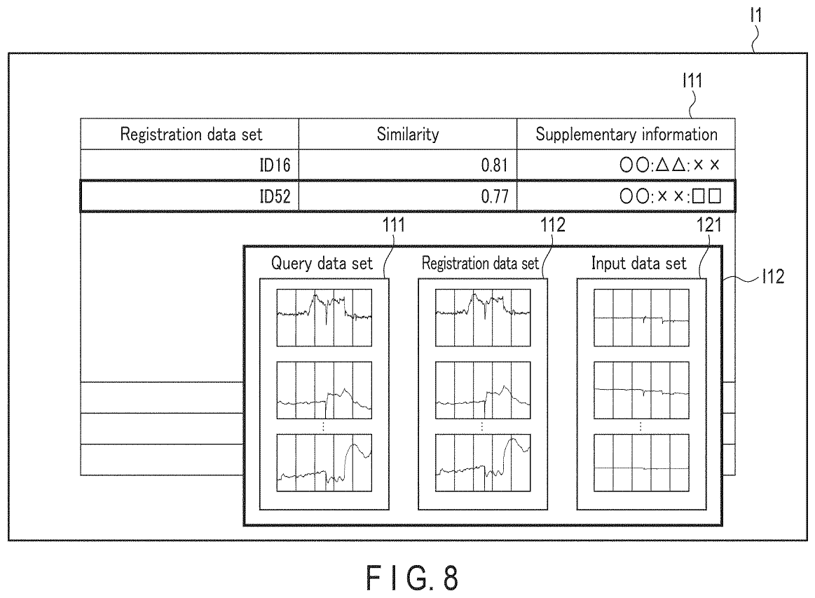

FIG. 8 is another diagram illustrating the display screen I1 that displays the search result. As illustrated in FIG. 8, the display field I11 and a display field 112 are displayed on the display screen I1. In the display field I11, a list of identification information of the registration data set, similarity, and supplementary information is displayed. The list is disposed in descending order of similarity. The row of the list displayed in the display field I11 is displayed so as to be selectable, for example. In FIG. 8, a row in which a character string “ID 52” is displayed as identification information is selected. In the selected row, for example, a frame surrounding the row of the list is a thick frame and is highlighted. In the display field 112, in a case where a row of the list displayed in the display field I11 is selected, information about the registration data set associated with the row of the selected list is displayed. For example, time-series data of the registration data set indicated in the selected row and the input data set based on the registration data set is displayed in the display field 112. The display field I12 is superimposed and displayed on the list so as not to cover the selected row of the list. By displaying the registration data set indicated in the row of the selected list and the input data set based on the registration data set, the user can easily consider whether the registration data set displayed in the list is a desired registration data set.

In a case where step S17 is performed, the search processing of the registration data set similar to the query data set according to the first embodiment ends.

Note that the present embodiment is applicable even in a case where there is one registration data stored in the database 120. As an example, the search unit 15 generates a search result using a registration data set having a predetermined threshold value or more as a registration data set similar to the query data set, and generates a search result not using a registration data set having a value less than the predetermined threshold value as a registration data set similar to the query data set. The similarity 141 is not limited to the above content. For example, the similarity 141 may be a reconstruction error itself between the input data set 121 and the output data set 131.

Here, according to the first embodiment, the input data set representing the difference between the query data set and the registration data set is input to the trained model, and by using the similarity based on the output data set output by the trained model, similar data search based on the minute fluctuations as well as a short distance between data is possible, and furthermore, it is possible to improve the search accuracy of the registration data set in which the minute fluctuations of the query data set are similar. In addition, by displaying the search result using the similarity based on the reconstruction error, the user can easily identify data similar to the query data.

In addition, the present embodiment is applied to search for plant amount data related to monitoring and control of an operation state of a plant, thereby achieving the following effects. From the measurement date and time, the name of the sensor, and the like associated with the searched past process quantity data, it is possible to access the past trouble record and quickly perform the cause analysis, and eventually, it is possible to support measures in a case where an anomaly occurs. In addition, by constantly searching past process quantity data similar to the current process quantity data, it is possible to monitor a degree of similarity at any time and determine the current soundness, and eventually, it is possible to support soundness evaluation. Furthermore, it is possible to access the operation record associated with the searched past process quantity data, and eventually, it is possible to support the setting of the operation condition by quickly grasping the information about the operation at the past time used to determine the current operation condition based on the information about the past operation of the plant.

### First Modification

The similar data search system according to the first modification further includes a training unit 17.

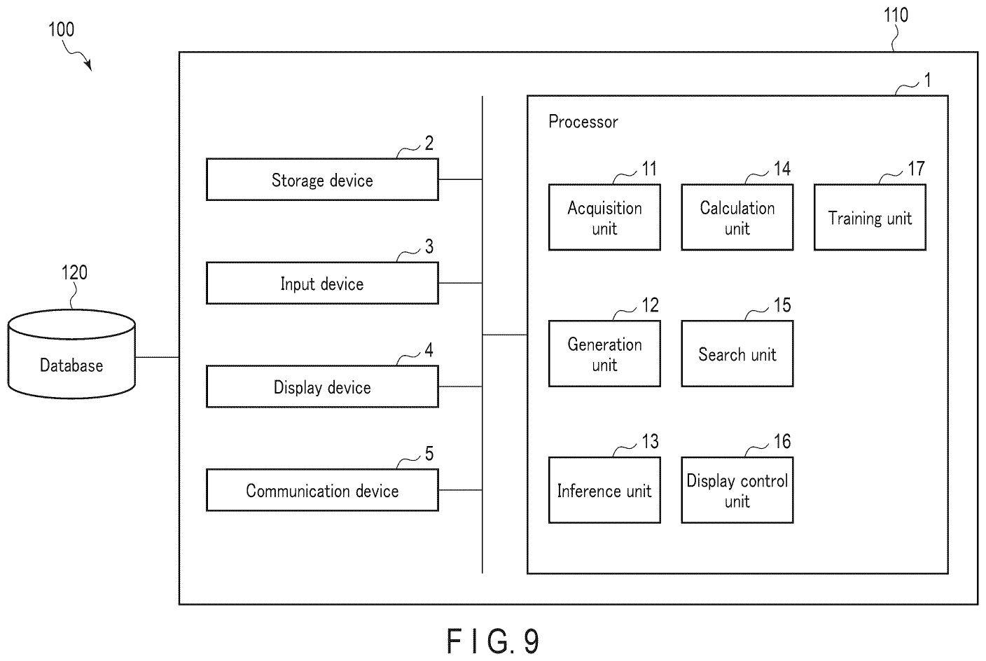

FIG. 9 is a diagram illustrating a hardware configuration example of the similar data search system 100 according to the first modification. As illustrated in FIG. 9, the similar data search system 100 includes the information processing apparatus 110 and the database 120. The information processing apparatus 110 is a computer including the processor 1, the storage device 2, the input device 3, the display device 4, and the communication device 5. Transmission and reception of data and various signals of the processor 1, the storage device 2, the input device 3, the display device 4, and the communication device 5 are performed via a bus (Bus). As an example, the similar data search system 100 is a system in which the information processing apparatus 110 is an edge device such as a personal computer and the database 120 is a server computer.

The database 120 stores a plurality of registration data sets including measurement values of a plurality of sensors.

As illustrated in FIG. 9, the processor 1 includes functional configurations such as the acquisition unit 11, the generation unit 12, the inference unit 13, the calculation unit 14, the search unit 15, the display control unit 16, and the training unit 17.

The acquisition unit 11 acquires two different registration data sets among the plurality of registration data sets.

The generation unit 12 generates a training data set representing a difference between two different registration data sets of the plurality of registration data sets based on the two different registration data sets of the plurality of registration data sets.

The training unit 17 trains a machine learning model to be used by the inference unit 13. The training unit 17 trains the machine learning model so that, for example, a training data set is input and an output data set for the input training data set is output.

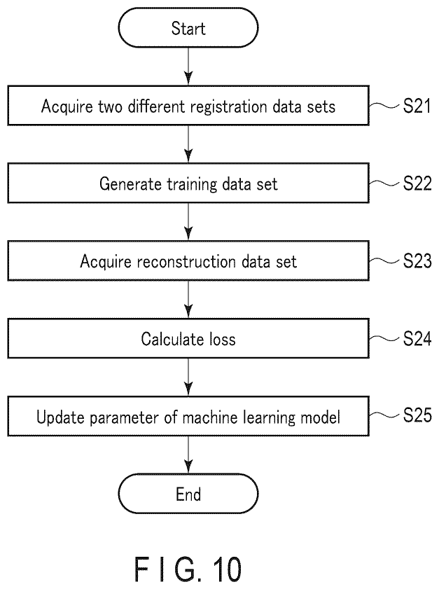

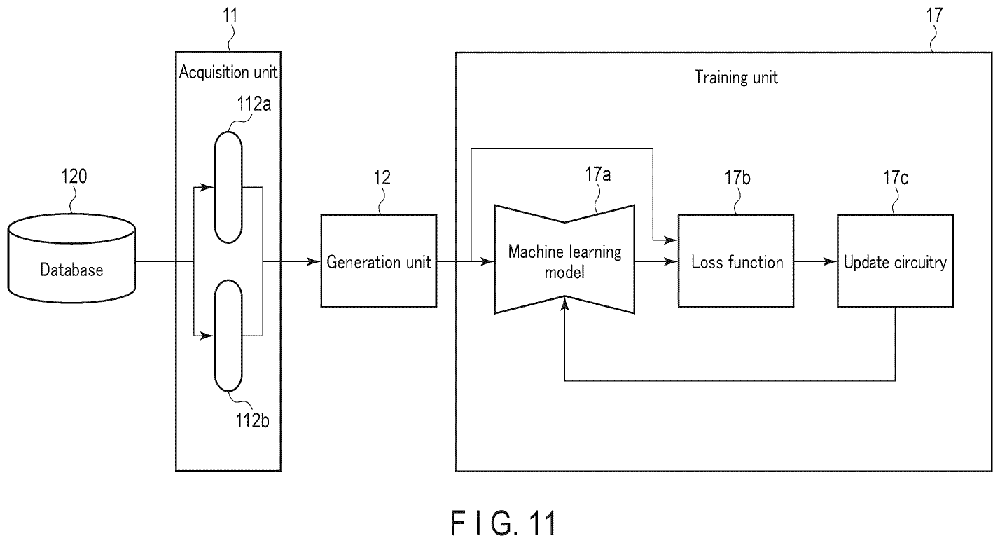

FIG. 10 is a diagram illustrating a processing procedure for training a machine learning model according to the first modification. Furthermore, FIG. 11 is a diagram schematically illustrating a flow of training processing according to the first modification.

Hereinafter, description will be given with reference to FIGS. 10 and 11.

As illustrated in FIG. 10, the acquisition unit 11 acquires two different registration data sets among the plurality of registration data sets stored in the database 120 (step S21). As an example, in a case of executing the training processing of an untrained machine learning model 17a, the acquisition unit 11 acquires a combination of a first registration data set 112a and a second registration data set 112b a plurality of times according to a preset batch size of the training data or the number of epochs of the training processing. More specifically, the acquisition unit 11 acquires a combination of two different registration data sets among the plurality of registration data sets without duplication for all of the plurality of registration data sets.

Specifically, in a case where the number of the plurality of registration data sets stored in the database 120 is N from 1 to N, assuming that the first registration data set 112a is a registration data set 1, there are N−1 kinds of second registration data sets 112b from the registration data set 2 to the registration data set N. Since the first registration data set is selected from the registration data set 1 to the registration data set N, the acquisition unit 11 acquires N·(N−1) combinations of two registration data sets. The similar data search apparatus according to the first modification can improve the training accuracy by training the untrained machine learning model 17a for all the registration data sets stored in the database 120.

However, as the number of registration data sets stored in the database 120 increases, the number of combinations of two registration data sets to be acquired increases by O(N²). Therefore, there is a case where the training processing is not ended in a realistic time due to restrictions such as the memory of the information processing apparatus 110 and the processing speed of the processor 1. Incidentally, for example, during steady operation of a power plant or the like including a thermal power plant, a large number of pieces of process quantity data having substantially the same fluctuation are included in a plurality of registration data sets. In a plurality of registration data sets including process quantity data having substantially the same fluctuation, increasing the number of combinations to be acquired does not increase significant information for training and does not significantly improve training accuracy, thus reducing the significance of generating a training data set for all combinations of the plurality of registration data sets stored in the database 120.

In such a case, the processing of acquiring two different registration data sets randomly selected from among the plurality of registration data sets stored in the database 120 is executed a predetermined number of times without acquiring two registration data sets for all the combinations of the registration data sets. The predetermined number of times is defined based on the time required for the generation unit 12 to generate the training data set. For example, the predetermined number of times may be defined so that the processing in which the generation unit 12 generates the training data set ends in a realistic time. By acquiring two different registration data sets randomly selected from the plurality of registration data sets stored in the database 120 a predetermined number of times, it is possible to reduce the number of combinations of first registration data 112a and second registration data 112b acquired by the acquisition unit 11 without reducing the training accuracy.

In a case where step S21 is performed, the generation unit 12 generates a training data set as a difference between the two registration data sets acquired in step S21 (step S22). In a case where the first registration data set 112a and the second registration data set 112b close to each other are acquired, in the process quantity data of the plant, the first registration data set 112a and the second registration data set 112b often have similar operation states. Specifically, the first registration data set 112a and the second registration data set 112b can be treated as plant amount data in which the fluctuation common between the two registration data sets and the minute fluctuation are combined.

In the process quantity data of the plant, the common fluctuation between the first registration data set 112a and the second registration data set 112b is complicated, and the minute fluctuation to be focused on in similar data search may be buried in the common fluctuation, and desired similar data may not be searched. In a case where the data distance between the first registration data set 112a and the second registration data set 112b is close, the training data set that is the difference cancels out the common fluctuation between the first registration data 112a and the second registration data set 112b, and represents the difference between a first minute fluctuation of the first registration data set 112a and a second minute fluctuation of the registration data set 112b. By the generation unit 12 executing the difference between the first registration data set 112a and the second registration data set 112b, it is possible to generate a training data set representing the difference between the first registration data set 112a and the second registration data set 112b.

In a case where step S22 is performed, the training unit 17 inputs the training data set generated in step S22 to the untrained machine learning model 17a, and acquires the reconstruction data set output by the untrained machine learning model 17a (step S23). The machine learning model 17a is, for example, an autoencoder. By training the untrained machine learning model based on the training data set, the machine learning model 17a can learn about the first minute fluctuation and/or the second minute fluctuation in which a common fluctuation between the two registration data sets is excluded.

In a case where step S23 is performed, the training unit 17 calculates a loss based on the training data set input to the untrained machine learning model 17a in step S22 and the reconstruction error data set calculated in step S23 (step S24). Hereinafter, features the machine learning model 17a learns will be described.

In a case where the distance between the first registration data 112a and the second registration data 112b is short, the plant at the time of acquiring the first registration data 112a and the plant at the time of acquiring the second registration data 112b are in similar operation states in many cases. Registration data sets acquired in mutually similar operation states have features of mutually similar minute fluctuations. On the other hand, in a small number of cases, even in a case where the distance between the first registration data 112a and the second registration data 112b is short, the features of minute fluctuations between the registration data sets may be different from each other. In this case, the plant at the time of acquisition of the first registration data 112a and the plant at the time of acquisition of the second registration data 112b are not in similar operation states. Since the training processing is statistical processing, training of the untrained machine learning model 17a is performed based on features of data with the dominant number of training data sets, and features of a small number of data do not significantly affect training of the untrained machine learning model 17a. That is, the untrained machine learning model 17a is trained on the feature of the minute fluctuation between the process quantity data with the similar operation state.

The untrained machine learning model 17a can have various network configurations, but training may be unstable unless the configuration has a bottleneck structure. Therefore, hereinafter, details of a loss function 17b in a case where the untrained machine learning model 17a is an autoencoder that reduces the number of dimensions of input data and then outputs data restored to the same number of dimensions as the input data as output data will be described.

The autoencoder is trained so that the closer the distance between the first registration data 112a and the second registration data 112b is, the smaller the reconstruction error is. In the above training process, the feature in a small number of cases where the operation state of the plant is not similar even if the distance is short can be considered to be statistically excluded from the training. The loss function L for realizing such training is expressed by the following Expression (1), where N is a batch size, Xₖ is a training data set, Xₖ′ is output data (1≤k≤N), |Xₖ∥² is S(Xₖ) and δ is any constant for preventing division by zero.

$$L = {\sum }_{k = 1}^{N} \frac{1}{S ( {x}_{k} ) + δ} \cdot {‖ {x}_{k} - x {}_{k}^{′} ‖}^{2} \qquad ( 1 )$$

In Expression (1), the shorter the distance between the first registration data set 112a and the second registration data 112b, that is, the smaller the L2 norm ∥Xₖ∥² of the training data set, the greater the contribution of ∥Xₖ−Xₖ′∥², which is the L2 norm of the reconstruction error between the k-th training data set and the output data set, to the loss. The smaller ∥Xₖ−Xₖ′∥², the smaller the loss. As a result, training is performed so that the shorter the distance between the first registration data 112a and the second registration data 112b, the smaller the reconstruction error.

In addition, the following Expression (2), which is an evolution form of Expression (1), may be used as the loss function L.

$$L = \frac{1}{{w}_{a}} {\sum }_{k = 1}^{N} \frac{1}{S ( {x}_{k} ) + δ} \cdot {‖ {x}_{k} - x {}_{k}^{′} ‖}^{2} + max ( margin - \frac{1}{{w}_{b}} {\sum }_{k = 1}^{N} S ( {x}_{k} ) \cdot {‖ {x}_{k} - x {}_{k}^{′} ‖}^{2} , 0 ) \qquad ( 2 )$$

where max( ) is a max function. margin is any constant. As margin, for example, a distance between the first registration data set 112a and the second registration data 112b used for training, that is, a median value of the size of the training data may be used. Wₐ and W_{b} are normalization constants expressed by the following expressions (3) and (4).

$${w}_{a} = {\sum }_{k = 1}^{N} \frac{1}{{S}_{( {x}_{k} )} + δ} \qquad ( 3 )$$

$${w}_{b} = {\sum }_{k = 1}^{N} S ( {x}_{k} ) \qquad ( 4 )$$

Expression (2) is an expression obtained by multiplying the term of Expression (1) by Expression (3) and adding the term of the max function. The first term of Expression (2) contributes to the loss as in Expression (1). In the second term of Expression (2), as ∥Xₖ∥² is larger, the contribution of ∥Xₖ−Xₖ′∥², which is the L2 norm of the reconstruction error, to the loss is larger, and as ∥Xₖ−Xₖ′∥² is larger, the loss is smaller. That is, in Expression (2), as in Equation (1), the shorter the distance, the smaller the reconstruction error, and in addition, due to the action of the second term, the longer the distance, the larger the reconstruction error. Expression (2) is an expression for training the untrained machine learning model 17a explicitly indicating that the shorter the distance, the more similar the distance, and the longer the distance, the less similar the distance.

In a case where step S24 is performed, the training unit 17 updates the parameters of the untrained machine learning model 17a so as to minimize the loss calculated in step S24 (step S25). The update of the parameter is executed by an update circuit 17c, for example. The update circuitry 17c updates the parameters of the untrained machine learning model 17a using a parameter optimization algorithm of deep learning such as Adam or SGD based on the loss calculated in step S24.

The processing of steps S21 to S25 is repeated until the parameter update end condition is satisfied, while changing the combination of the two registration data sets. For example, the update end condition is set to any condition such as that the number of iterations of steps S21 to S25 has reached a predetermined number of times or that the loss is less than a predetermined value. In a case where the update end condition is satisfied, the training processing of the machine learning model according to the first modification is ended.

Note that the registration data set used for the training data set is not limited to the data set stored in the database 120. For example, the training data set may be generated based on a data set stored in an external storage device, or the training data set may be generated based on a data set stored in a portable storage medium.

Hereinafter, a case where a trained autoencoder trained by the training processing according to the first modification is used for the inference unit 13 will be described.

A case where the distance between the query data set and the first registration data is equal to the distance between the query data set and the second registration data set will be described. In this case, the L2 norm of the first input data set, which is the difference between the query data set and the first registration data, is equal to the L2 norm of the second input data set, which is the difference between the query data set and the second registration data. The trained autoencoder has learned the feature, of the training data set, that is a difference between two different registration data sets of the plurality of registration data sets stored in the database 120. Thus, in a case where the feature of the first input data set is more similar to the feature the trained autoencoder has learned than the feature of the second input data set, the first reconstruction error, which is the difference between the first input data set and the first output data set, is smaller than the second reconstruction error, which is the difference between the second input data set and the second output data set. As a result, the first reconstruction error is smaller than the second reconstruction error.

Therefore, in a case where the distance between the query data set and the registration data set is small, the registration data set is not assumed to be the data set similar to the query data set, but the registration data set having a similar feature of the minute fluctuation of the process quantity data in a more similar operation state in addition to the distance is data similar to the query data set.

Note that the training unit 17 may train an untrained machine learning model using the feature of the registration data set. Since the feature is data organized so as to express the feature of the original process quantity data, it is possible to improve the learning accuracy of the untrained machine learning model.

According to the first modification, it is possible to generate a machine learning model trained focusing on the minute fluctuation in which the fluctuation common between two registration data sets are excluded. Furthermore, the inference unit 13 uses the machine learning model trained by the training unit 17, so that it is possible to improve the search accuracy of the registration data set in which minute fluctuations of the query data set are similar.

### Second Modification

The similar data search system according to the second modification further includes a preprocessing unit 18.

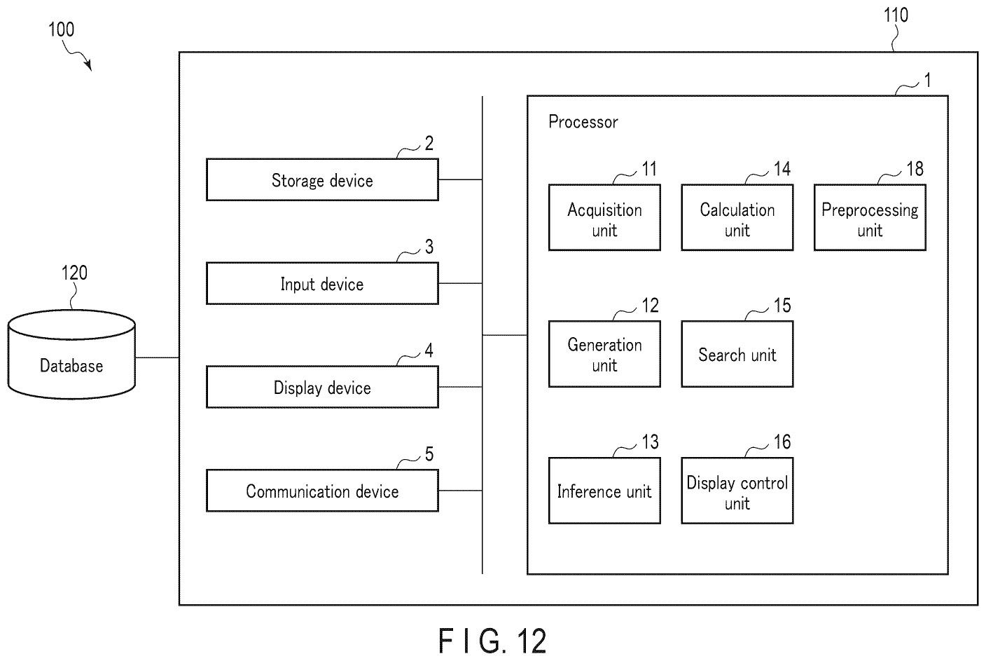

FIG. 12 is a diagram illustrating a hardware configuration example of a similar data search system 100 according to the second modification. As illustrated in FIG. 12, the similar data search system 100 includes the information processing apparatus 110 and the database 120. The information processing apparatus 110 is a computer including the processor 1, the storage device 2, the input device 3, the display device 4, and the communication device 5. Transmission and reception of data and various signals of the processor 1, the storage device 2, the input device 3, the display device 4, and the communication device 5 are performed via a bus (Bus). As an example, the similar data search system 100 is a system in which the information processing apparatus 110 is an edge device such as a personal computer and the database 120 is a server computer.

As illustrated in FIG. 12, the processor 1 includes functional configurations such as the acquisition unit 11, the generation unit 12, the inference unit 13, the calculation unit 14, the search unit 15, the display control unit 16, and the preprocessing unit 18.

The preprocessing unit 18 includes a first autoencoder and a second autoencoder. The first autoencoder reduces and restores dimensions of the query data set and the registration data set. Specifically, the first autoencoder receives the query data set as a first intermediate data set, reduces the dimension of the input first intermediate data set, and outputs a first reconstruction data set obtained by restoring the first intermediate data set with the reduced dimension to a data set having a dimension same as that of the input first intermediate data set or a first feature amount data set which is the first intermediate data set with a reduced dimension. In addition, the first autoencoder receives the registration data set as the first intermediate data set, and outputs the first reconstruction data set and the first feature amount data set.

The second autoencoder is an autoencoder different from the first autoencoder that reduces and restores dimensions of the query data set and the registration data set. Specifically, the second autoencoder receives a second intermediate data set that is a difference between the first intermediate data set and the first reconstruction data set output by the first autoencoder with respect to the input of the first intermediate data set, reduces the dimension of the input second intermediate data set, and outputs a second feature amount data set that is a second intermediate data set with a reduced dimension.

The generation unit 12 generates the input data set based on the first feature amount data set based on the query data set and the first feature amount data set based on the registration data set or based on the second feature amount data set based on the query data set and the second feature amount data set based on the registration data set.

The database 120 stores a first feature amount data set based on the registration data set and a second intermediate output data set.

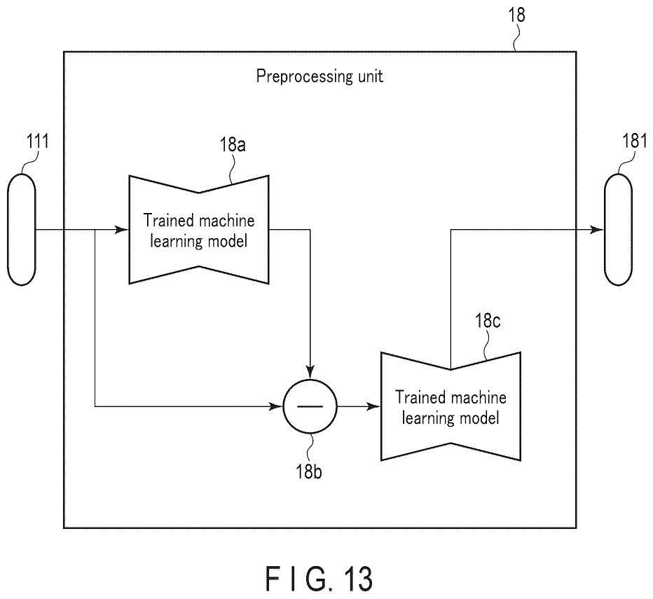

FIG. 13 is a block diagram illustrating a flow of generation processing of a first preprocessing data set of the preprocessing unit 18 according to the second modification. The generation processing of the first preprocessing data set may be executed between step S11 and step S12 in FIG. 3. As illustrated in FIG. 13, the query data set 111 acquired in step S11 as the first intermediate data set is input to a trained machine learning model 18a and a first difference circuit 18b. The trained machine learning model 18a is, for example, a first autoencoder. Hereinafter, the trained machine learning model 18a is a first autoencoder 18a. The first autoencoder 18a reconstructs the input query data set 111 to output the first reconstruction data set. The first reconstruction data set is a data set in which the rough fluctuation of the multivariate time-series data predicted to be acquired during normal plant operation are reproduced. The rough fluctuation indicates, for example, a low-frequency component in a case where the time-series data is represented by synthesis of a high-frequency component and a low-frequency component. The first reconstruction data set output by the first autoencoder 18a is input to a difference circuit 18b.

The difference circuit 18b outputs a second intermediate data set that is a difference between the input query data set 111 and the input first reconstruction data set. Since the second intermediate data set is the difference between the query data set 111 and the first reconstruction data set, the second intermediate data set is a data set in which the rough fluctuation of the multivariate time-series data at the normal time is reduced, and the minute fluctuation is extracted. The second intermediate data set output by the first difference circuit is input to a trained machine learning model 18c. The trained machine learning model 18c is, for example, a second autoencoder. Hereinafter, the trained machine learning model 18c is a second autoencoder 18c.

The second autoencoder 18c outputs a second feature amount data set in which the dimension of the input second intermediate data set is reduced. The second feature amount data set is a data set in which the feature related to the minute fluctuation of the multivariate time-series data is extracted. For example, in a case where the time-series data is represented by synthesis of a high-frequency component and a low-frequency component, the minute fluctuation indicates a high-frequency component. The preprocessing unit 18 outputs the second feature amount data set as a first preprocessing data set 181.

Note that the data set output by the preprocessing unit 18 is not limited to the second feature amount data set. For example, the data set output by the preprocessing unit 18 may be the first feature amount data set. The first feature amount data set is a data set in which the first intermediate data set is input to the first autoencoder 18a and the feature amount regarding the rough fluctuation of the output multivariate time-series data is extracted. In addition, the preprocessing unit 18 may appropriately select the first feature amount data set or the second feature amount data set according to the selection of the user via the input device 3 or the like, and output only the selected data set as the first preprocessing data set 181. In this case, unselected data sets may not be calculated. For example, in a case where the first feature amount data set is selected, the first autoencoder 18a may not output the first reconstruction data set, and the second autoencoder 18c may not output the second feature amount data set. In a case where the second feature amount data set is selected, the first autoencoder 18a may not output the first feature amount data set. By the user's selection, the first preprocessing data set 181 is selectively output as the first feature amount data set or the second feature amount data set, so that the rough fluctuation or the minute fluctuation can be selectively used in similar data search. Furthermore, in a case where the first feature amount is selected as the first preprocessing data set 181, the second feature amount data set is not calculated, so that it is possible to reduce the time required for similar data search.

Furthermore, the second modification can be applied to a configuration including only a decoder part of the autoencoder trained as the first autoencoder 18a or the second autoencoder 18c in a case where the first autoencoder 18a or the second autoencoder 18c does not output the reconstruction data set.

In addition, the data input to the preprocessing unit 18 is not limited to raw data. For example, the query data set 111 may be a data set based on data obtained by extracting some time-series data of the multivariate time-series data.

By performing the processing procedure of FIG. 13 on the registration data set, the preprocessing unit 18 outputs the first feature amount data set and the second feature amount data set based on the registration data set as a second preprocessing data set. The second preprocessing data set may be generated by the preprocessing unit 18 at the timing in a case where the registration data set is stored in the database 120 and stored in the database 120. At this time, a first feature amount data set and a second feature amount data set may be generated for one registration data set. Since the second preprocessing data set is stored in the database 120 in advance, it is possible to reduce the time required to generate the second preprocessing data set at the time of similar data search.

The generation unit 12 outputs the input data set by taking a difference between the first preprocessing data set 181 and the second preprocessing data set. As an example, the generation unit 12 outputs a difference between the first preprocessing data set and the second preprocessing data set according to the selection of the user as an input data set. Specifically, in a case where the first preprocessing data set is the first feature amount data set, the generation unit 12 uses only the second preprocessing data set that is the first feature amount data set for generation of the input data set. Furthermore, in a case where the first preprocessing data set is the second feature amount data set, the generation unit 12 uses only the second preprocessing data set that is the second feature amount data set for generation of the input data set. The above processing corresponds to step S12 in FIG. 3. After the above processing, processing similar to that after step S13 in FIG. 3 can be applied.

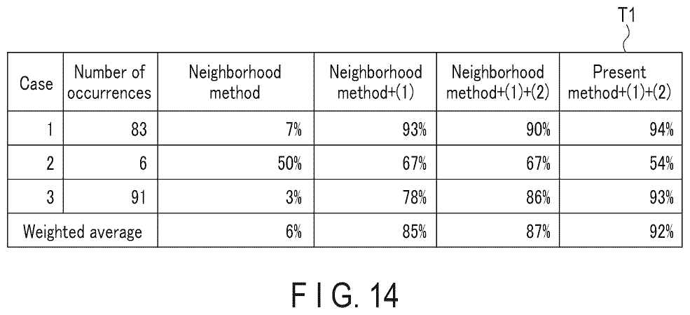

FIG. 14 is a diagram illustrating a verification result with the power plant operation data. As illustrated in FIG. 14, in each of the four cases, the search accuracy in a case where the similar data is searched using the four methods is illustrated in a table T1 of 5 rows and 6 columns. In the first row of T1, six character strings of “case”, “the number of occurrences”, “neighborhood method”, “neighborhood method+ (1)”, “neighborhood method+ (1)+ (2)”, and “present method+ (1)+ (2)” are described in the six cells in order from the left. The case represents an operation state of the plant. The number of occurrences represents the number of times the case occurs. Since the similar data search processing for the case is executed every time the case occurs, the number of occurrences is equal to the number of similar data search processing using the case as the query data set. The search accuracy is a ratio of the number of times a data set similar to the query data set is searched to the number of times of similar data search processing. The search accuracy may be referred to as an accuracy rate, for example. The neighborhood method represents a general k-neighborhood method. The present method represents a similar data search method using the similar data search system according to the first embodiment. (1) indicates that a data set based on data from which some time-series data of the multivariate time-series data are extracted is used as the query data set and the registration data set. (2) indicates that the low-dimensional feature intermediate output by the first autoencoder or the second autoencoder is used. That is, the present method+ (1)+ (2) represents a similar data search method using the similar data search system according to the second modification. Targeted plant amount data was validated against 5-year data of approximately 300 process quantities of the power plant. In each method, the weighted average is a value obtained by dividing the sum of the values in which the number of occurrences is weighted with the search accuracy for each case by the sum of the number of occurrences for each case. According to the table T1, in the case 1, the case 3, and the weighted average, it is shown that the similar data search system according to the second modification has a search accuracy higher than that of each of the neighborhood method, the neighborhood method+ (1), and the neighborhood method+ (1)+ (2).

According to the second modification, abnormal plant amount data can be extracted from plant amount data including a complicated component. In addition, it is possible to improve the search accuracy of similar data in the power plant.

### Third Modification

The machine learning model according to the third modification can be applied to a machine learning model other than the autoencoder. For example, the present embodiment can be applied to a machine learning model such as a multi-layer perceptron (MLP), a convolutional neural network (CNN), or a recurrent neural network (RNN). These may be appropriately used depending on the type of data of the query data set to be input.

According to the third modification, the similar data search system can be applied to multivariate time-series data, image data and/or video data other than plant amount data. Multivariate time-series data includes weather data, electroencephalogram data, and physical activity data, and the like. Image data and video data includes facial photograph data, fingerprint data, and a drive recorder, and the like.

### Fourth Modification

The calculation unit 14 according to the fourth modification calculates the similarity based on the intermediate output data set which is an intermediate output of the trained model. The intermediate output data set is, for example, a feature in which the dimension of the input data set is reduced. Specifically, the calculation unit 14 may calculate the similarity based on the feature in which the autoencoder used for the inference unit 13 has reduced dimensions. More specifically, the calculation unit 14 calculates the L2 norm of the feature whose dimension has been reduced by the autoencoder as the similarity. However, the intermediate output data set is not limited to the feature whose dimension has been reduced by the autoencoder, and the present embodiment can be applied even if any state variable in the configuration is used in the trained model.

According to the fourth modification, by calculating the similarity based on the intermediate output data that is the intermediate output of the trained model, the similarity can be calculated even in a case where the difference cannot be obtained.

### Second Embodiment

The first embodiment has been treated as a similar data search system. The second embodiment is a training system that trains a machine learning model of the similar data search system according to the first embodiment. Hereinafter, a training system according to the second embodiment will be described. However, components having the same functions as those of the first embodiment are denoted by the same reference numerals, and redundant description will be given only when necessary.

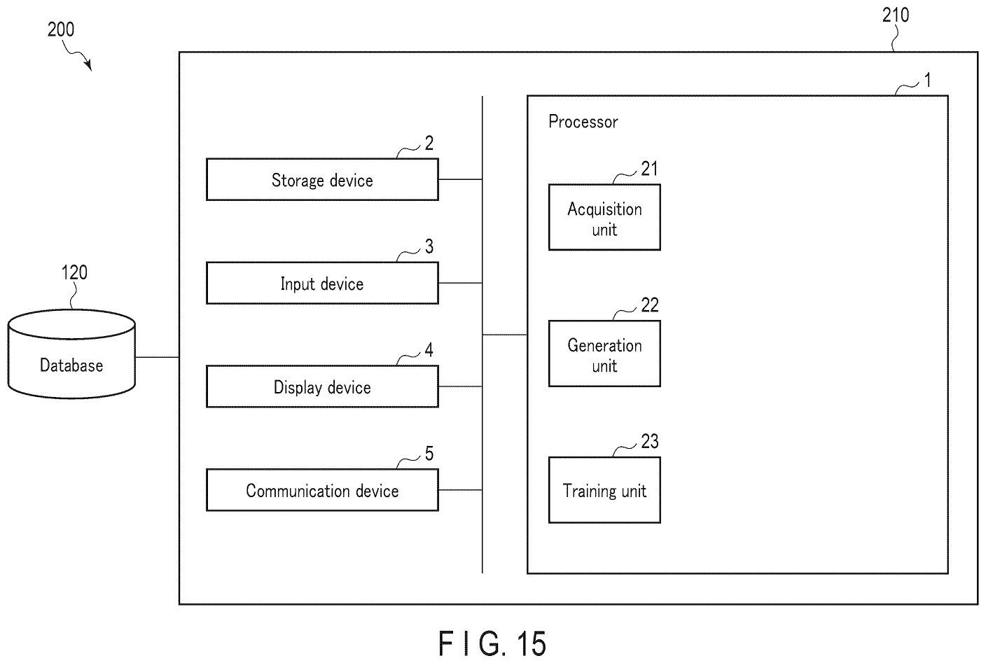

FIG. 15 is a diagram illustrating a configuration example of a training system 200 according to the second embodiment. As illustrated in FIG. 15, the training system 200 includes an information processing apparatus 210 and a database 120. The information processing apparatus 210 is a computer including a processor 1, a storage device 2, an input device 3, a display device 4, and a communication device 5. Transmission and reception of data and various signals of the processor 1, the storage device 2, the input device 3, the display device 4, and the communication device 5 are performed via a bus (Bus). As an example, the training system 200 is a system in which the information processing apparatus 210 is an edge device such as a personal computer and the database 120 is a server computer.

As illustrated in FIG. 15, the processor 1 has functional configurations such as an acquisition unit 21, a generation unit 22, and a training unit 23.

The acquisition unit 21 corresponds to the acquisition unit 11 according to the first modification. The generation unit 22 corresponds to the generation unit 12 according to the first modification. The training unit 23 corresponds to the training unit 17 according to the first modification.

According to the second embodiment, it is possible to generate a trained model for use in similar data search without having a function related to similar data search.

Thus, according to some embodiments described above, it is possible to provide a similar data search system, a training system, and a similar data search method capable of improving the search accuracy of data having similar minute fluctuations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A similar data search system comprising
a processor
acquiring a query data set including measurement values of a plurality of sensors, generating, based on the query data set and a registration data set, an input data set representing a difference between the query data set and the registration data set, inputting the input data set to a trained model, acquiring an output data set output by the trained model or an intermediate output data set that is an intermediate output of the trained model, calculating similarity between the query data set and the registration data set based on the output data set or the intermediate output data set, and searching a database based on the similarity, wherein the database stores a registration data set including the measurement values of the plurality of sensors.

2. The similar data search system according to claim 1, wherein the trained model is an autoencoder that receives the input data set, reduces a dimension of the input data set, and outputs the output data set restored to the dimension of the input data set.

3. The similar data search system according to claim 2, wherein the processor calculates the similarity based on a reconstruction error between the input data set and the output data set.

4. The similar data search system according to claim 1, wherein the query data set and the registration data set are one of a plurality of segments among a plurality of segments obtained by dividing multivariate time-series data every predetermined time or a feature extracted from the one segment.

5. The similar data search system according to claim 4, wherein the multivariate time-series data is a plurality of pieces of input time-series data respectively corresponding to a plurality of process quantities generated in a target facility including a plant.

6. The similar data search system according to claim 1, wherein the processor generates a difference between the query data set and the registration data set as the input data set.

7. The similar data search system according to claim 1, wherein the query data set and the registration data set include multivariate time-series data, image data and/or video data,
Multivariate time-series data includes weather data, brain wave data, and physical activity data,
Image data and video data includes facial photograph data, fingerprint data, and a drive recorder.

8. The similar data search system according to claim 1, wherein the similarity is an L2 norm of the output data set or the intermediate output data set.

9. The similar data search system according to claim 1, further comprising a display unit that displays a search result of the registration data set similar to the query data set.

10. The similar data search system according to claim 9, wherein
the database stores the registration data set in association with supplementary information including a measurement date and time and/or a name of each of the sensors, and wherein
the processor displays the supplementary information associated with the registration data set included in the search result together with the search result.

11. The similar data search system according to claim 1, wherein
the database stores a plurality of registration data sets including measurement values of the plurality of sensors, and wherein
the processor generates the input data set for each of all registration data sets included in the plurality of registration data sets.

12. The similar data search system according to claim 1, wherein
the database stores a plurality of registration data sets including measurement values of the plurality of sensors, and wherein
the processor generates a search result in which some or all of the plurality of registration data sets are disposed in order of a magnitude relationship between the similarities.

13. The similar data search system according to claim 1, wherein
the processor further includes a first autoencoder and a second autoencoder different from the first autoencoder, wherein
the first autoencoder receives the query data set as a first intermediate data set, reduces a dimension of the input first intermediate data set, receives a first reconstruction data set obtained by restoring the first intermediate data set with the reduced dimension to a data set having a dimension same as the dimension of the input first intermediate data set or a first feature amount data set that is the first intermediate data set with the reduced dimension, and the registration data set as the first intermediate data set, and outputs the first reconstruction data set and the first feature amount data set, wherein
the second autoencoder receives a second intermediate data set that is a difference between the first intermediate data set and the first reconstruction data set or the first feature amount data set output by the first autoencoder with respect to an input of the first intermediate data set, reduces a dimension of the input second intermediate data set, and outputs a second feature amount data set that is the second intermediate data set with the reduced dimension, wherein
the database stores the first feature amount data set and the second feature amount data set based on the registration data set, and wherein
the processor generates the input data set based on the first feature amount data set based on the query data set and the first feature amount data set based on the registration data set or based on the second feature amount data set based on the query data set and the second feature amount data set based on the registration data set.

14. The similar data search system of claim 1, wherein
the database stores a plurality of registration data sets including measurement values of the plurality of sensors, and wherein
the processor generates the trained model by acquiring two different registration data sets of the plurality of registration data sets, generating a training data set representing a difference between the two registration data sets based on the two registration data sets, inputting the training data set, training a machine learning model to output the output data set with respect to the input training data set.

15. A training system comprising:
a database that stores a plurality of registration data sets including measurement values of a plurality of sensors; and
a processor trains a machine learning model to output an output data set with respect to the input training data set by acquiring two different registration data sets of the plurality of registration data sets, generating a training data set representing a difference between the two registration data sets based on the two registration data sets, inputting the training data set.

16. The training system according to claim 15, wherein
the machine learning model is an autoencoder, and wherein
the processor updates a parameter of the machine learning model so as to minimize a loss based on the training data set input to the machine learning model and a reconstruction error that is a difference between the training data set and an output data set output by the machine learning model with respect to the input training data set.

17. The training system of claim 16, wherein a loss function that calculates the loss has a term that correlates to a magnitude of the reconstruction error in a case where a size of the training data set is less than one.

18. The training system according to claim 15, wherein the processor executes processing of generating the training data set from the two registration data sets randomly selected from the plurality of registration data sets a predetermined number of times except for a combination of the two registration data sets.

19. The training system according to claim 18, wherein the predetermined number of times is defined based on a time required for processing in which the processor generates the training data set.

20. A similar data search method executed by a computer, the method comprising:
acquiring a query data set including measurement values of a plurality of sensors;
storing a registration data set including the measurement values of the plurality of sensors in a database;
generating, based on the query data set and a registration data set, an input data set representing a difference between the query data set and the registration data set;
inputting the input data set to a trained model and acquiring an output data set output by the trained model or an intermediate output data set that is an intermediate output of the trained model;
calculating similarity between the query data set and the registration data set based on the output data set or the intermediate output data set; and
searching the database based on the similarity.
